(19) United States
(12) Patent Application Publication
(10) Pub. No.: US 2009/0006091 A1
(43) Pub. Date: Jan. 1, 2009

(54) APPARATUSES AND METHODS FOR HANDLING RECORDED VOICE STRINGS

(75) Inventors: Sanna Lindroos, Tampere (FI); Vesa Huotari, Tampere (FI); Paivi Heikkila, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,488

(22) Filed: Jun. 29, 2007

(51) Int. Cl. G10L 15/00

(52) U.S. Cl. 704/243; 704/231; 704/235

(57) ABSTRACT

An apparatus, method, and computer program product for facilitating the identification and manipulation of recorded voice strings is provided. The apparatus includes a processor for receiving a voice string that has been recorded. The processor automatically assigns the recorded voice string a name that is indicative of the content of the voice string or of a characteristic of the voice string but which may include other information regarding the voice string. Thus, the voice string may be assigned a name that provides the user with an idea of the content or circumstance of the voice string when it was recorded without requiring the user to input a name for the recorded voice string. In this way, the user may be able to access the recorded voice string more easily. The apparatus may also include a microphone, memory element, and/or a display for presenting a list of recorded voice strings.

### TECHNOLOGICAL FIELD

Embodiments of the present invention relate generally to communications technology, devices and, more particularly, to naming and storing recorded voice strings.

### BACKGROUND

With the hectic pace of life and the numerous demands of family, co-workers, and friends, it can be easy for people to forget what they need to do or where they need to be. In an effort to stay on top of things, people have developed several ways of reminding themselves of their various responsibilities. Some people write notes to themselves and keep the notes in plain view, such as on their desk or stuck to the refrigerator door. Others commission their spouse or a friend to remind them to do something. However, notes may be misplaced under a stack of papers or may otherwise be lost, and spouses and friends may not remember their own tasks, let alone the tasks of others.

In the age of mobile terminals and telecommunications, some people have found it useful to record messages or voice memos as a reminder of the tasks they must accomplish. A father on his way to drop his children off at school may receive a phone call from his wife, for example, reminding him to pick up some milk on his way home from work that evening. Recognizing that there is an 80% chance he will forget to buy the milk in 9 hours when he leaves work, the father may use his mobile telephone to record a voice memo to himself: “Buy some milk tonight on the way home.”

Although voice memos and similar recorded voice strings may be useful reminders when listened to, the accumulation of such recorded voice strings may make it difficult for a user to properly sort through, access, and manipulate one voice string or another. The voice strings may be assigned generic names by the mobile terminal, such as “Sound(1),” and the busy user may not have the time or inclination to rename the recorded voice string. It may therefore require additional time and effort for a user to access each recorded voice string to find the ones he must act upon. Furthermore, some recorded voice strings may be forgotten, remaining on the mobile terminal long after the task has been (or should have been) completed and taking up valuable storage space on the mobile terminal, which may make it more difficult and cumbersome to access other voice strings in a timely and efficient manner.

Thus, there is a need for a way to facilitate the identification and manipulation of recorded voice strings without imposing additional requirements upon the user of the mobile terminal.

### BRIEF SUMMARY

An apparatus, method, and computer program product for facilitating the identification and manipulation of recorded voice strings is provided. The apparatus allows for the automatic assignment of a name that is indicative of the content of the voice string or of a characteristic of the voice string. In this way, the voice string may be assigned a name that provides the user with an idea of the content or circumstance of the voice string when it was recorded without requiring the user to input a name for the recorded voice string.

In one exemplary embodiment, an apparatus for facilitating communication is provided. The apparatus comprises a processor configured to receive a voice string that has been recorded, the processor further configured to automatically assign the recorded voice string a name indicative of at least one of the content or a characteristic of the voice string. In some embodiments, the processor may be configured to automatically assign the recorded voice string a name according to current location metadata and/or according to a date on which the voice string is recorded.

In some cases, the processor may be configured to automatically assign the recorded voice string a name according to a predetermined number of initial words of the recorded voice string. The processor may, for example, be configured to automatically convert a predetermined portion of the recorded voice string to the name using a speech-to-text feature.

In some embodiments, the apparatus may also include a microphone in communication with the processor and configured to receive a voice string for recording. A memory element that is in communication with the processor and that is configured to store the recorded voice string may also be included. The apparatus may further include a display in communication with the processor, and the processor may be configured to present upon the display an indication of each recorded voice string that has not been manipulated by a user. In some cases, the processor may be configured to present upon the display the name of each recorded voice string that has not been manipulated by the user.

In other exemplary embodiments, a method and computer program product for facilitating the identification and manipulation of recorded voice strings are provided. The method and computer program product initially receive a recorded voice string. A name indicative of at least one of the content or a characteristic of the voice string is then automatically assigned to the recorded voice string.

The name may be automatically assigned according to current location metadata and/or according to a date on which the voice string is recorded. The name may also be assigned according to a predetermined number of initial words of the recorded voice string. In some cases, the name may be assigned by automatically converting a predetermined portion of the recorded voice string to the name using a speech-to-text feature.

In some embodiments, storage of the recorded voice string in a memory element may be directed. Furthermore, an indication of each recorded voice string that has not been manipulated by a user may be presented upon a display. In some cases, the name of each recorded voice string that has not been manipulated by the user may be presented.

In another exemplary embodiment, an apparatus for facilitating the identification and manipulation of recorded voice strings is provided. The apparatus includes means for receiving a recorded voice string, as well as means for automatically assigning the recorded voice string a name indicative of at least one of the content or a characteristic of the voice string.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of a mobile terminal including a processor for automatically assigning a name according to an exemplary embodiment of the present invention;

FIG. 4 is a schematic representation of a voice string recorded on a mobile terminal according to an exemplary embodiment of the present invention; and

FIG. 5 illustrates a flowchart according to an exemplary embodiment for facilitating identification and manipulation of a recorded voice string.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

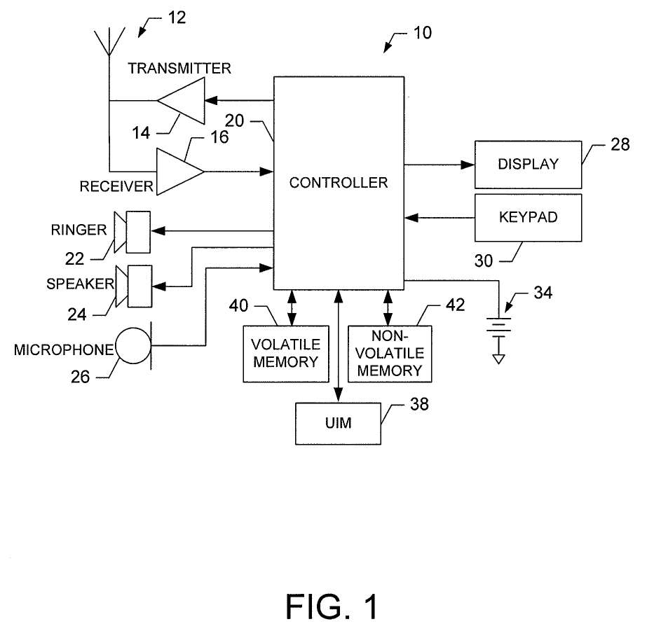

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, MP3 or other music players, cameras, laptop computers and other types of voice and text communications systems, can readily employ the present invention.

In addition, while several embodiments of the present invention will benefit a mobile terminal 10 as described below, embodiments of the present invention may also benefit and be practiced by other types of devices, i.e., fixed terminals. Moreover, the system and method of embodiments of the present invention will be primarily described in conjunction with mobile communications applications. It should be understood, however, that the system and method of the present invention can be utilized in conjunction with a variety of other applications, both in the mobile communications industries and outside of the mobile communications industries. Accordingly, embodiments of the present invention should not be construed as being limited to applications in the mobile communications industry.

In one embodiment, however, the apparatus for handling recorded voice strings is a mobile terminal 10. Although the mobile terminal may be embodied in different manners, the mobile terminal 10 of one embodiment includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 of this embodiment also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

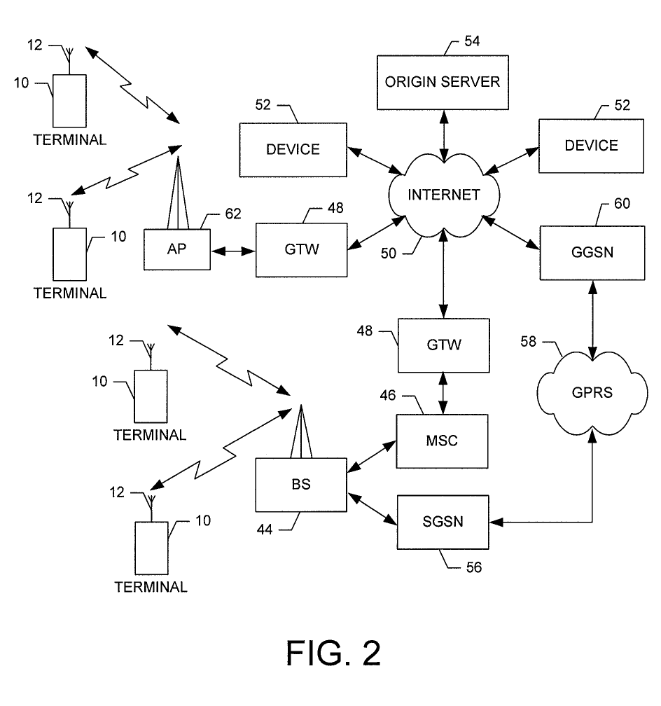

Referring now to FIG. 2, an illustration of one type of system that would benefit from and otherwise support embodiments of the present invention is provided. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a device 52 (two shown in FIG. 2), origin server 54 (one shown in FIG. 2), or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a device 52 and/or origin server 54 may be coupled to the mobile terminal 10 via the Internet 50, SGSN 56 and GGSN 60. In this regard, devices such as the device 52 and/or origin server 54 may communicate with the mobile terminal 10 across the SGSN 56, GPRS core network 58 and the GGSN 60. By directly or indirectly connecting mobile terminals 10 and the other devices (e.g., device 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the device 52, the origin server 54, and/or any of a number of other devices, to the Internet 50, the mobile terminals 10 can communicate with one another, the device, etc., to thereby carry out various functions of the mobile terminals 10, such as to transmit data, content or the like to, and/or receive content, data or the like from, the device 52. As used herein, the terms “data,” “content,” “information,” “signals” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to devices 52 across the Internet 50, the mobile terminal 10 and device 52 may be coupled to one another and communicate in accordance with, for example, RF, BT, IrDA or any of a number of different wireline or wireless communication techniques, including LAN, WLAN, WiMAX and/or UWB techniques. One or more of the devices 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the devices 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

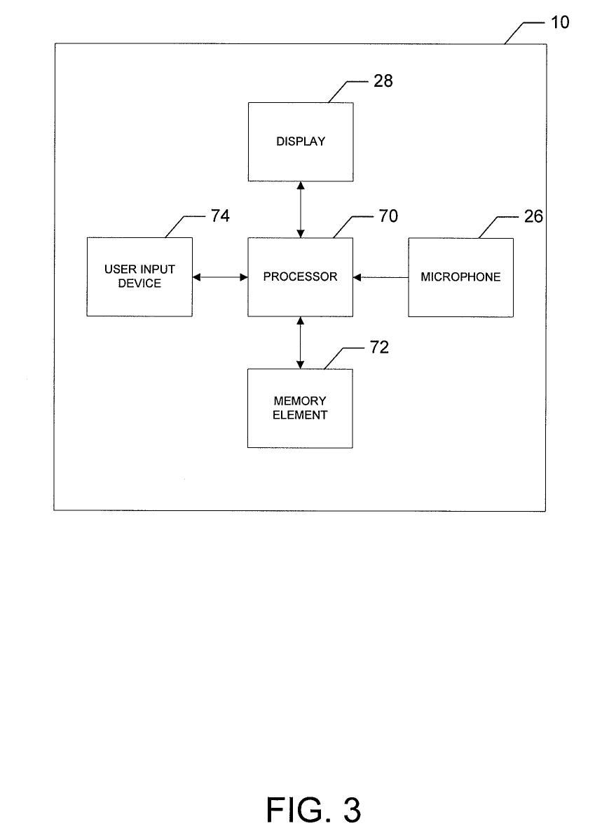

An exemplary embodiment of the invention will now be described with reference to FIG. 3, in which certain elements of a mobile terminal 10 for recording voice strings and handling recorded voice strings are displayed. The mobile terminal 10 of FIG. 3 may be employed, for example, in the environment depicted in FIG. 2 and may interact with other mobile terminals 10 or devices 52 depicted generally in FIG. 2. However, it should be noted that the system of FIG. 3, may also be employed with a variety of other devices, both mobile and fixed, and therefore, embodiments of the present invention should not be limited to use with devices such as the mobile terminal 10 of FIG. 1 or the devices 52 communicating via the network of FIG. 2.

In an exemplary embodiment, such as the one shown in FIG. 3, the mobile terminal 10 includes a processor 70, such as the controller 20 of FIG. 1, a microprocessor, an integrated circuit, or any other type of computing device for receiving a voice string that has been recorded. The processor 70 is further configured to automatically (i.e., without human intervention) assign the recorded voice string a name that is indicative of the content of the voice string or of a characteristic of the voice string, but which may include other information regarding the voice string. Thus, the voice string may be assigned a name that provides the user with an idea of the content or circumstance of the message when it was recorded without requiring the user to take any action to input a name for the recorded voice string. In this way, the user may be able to access and act upon the recorded voice string more easily, allowing the user to delete voice strings that have been satisfied to make room for new recordings as well as to recall older voice strings that may not yet have been acted upon.

The mobile terminal 10 may also include a microphone 26 in communication with the processor 70 (such as the microphone of FIG. 1) that is configured to receive the voice string for recording. The mobile terminal 10 may further include a memory element 72 in communication with the processor 70 that is configured to store the recorded voice string. For example, the memory element 72 may be the non-volatile memory 42 shown in FIG. 1 or any other component configured to store voice string data.

The voice string may include words spoken by a user of the mobile terminal 10 into the microphone 26. For example, a user of the mobile terminal 10 may use the mobile terminal 10 to record a voice memorandum (or voice memo) to herself as a reminder of a task to be done. The user may be walking from the parking garage, where she has parked her car, to her office when she passes by a store that sells greeting cards. The sight of the birthday cards on display through the window of the store may remind her that her brother's birthday is the following week and that she has yet to send him a card. As she is unable to complete this task at the moment and at the same time doesn't want to forget her brother's birthday, the user may reach for her mobile terminal (e.g., her mobile phone) to record herself a message. She may, for example, activate a voice recording application on her mobile terminal by pressing one or more hot keys that she previously chose as the keys to initiate a voice recording, such as *55, and begin speaking into the microphone of the mobile terminal to record her memo. In the situation described above, for example, the user may record the voice string “Send Bob a birthday card by Friday.”

The mobile terminal 10 may also include a display 28 in communication with the processor 70, such as the display 28 depicted in FIG. 1. The processor 70 may be configured to present upon the display 28 an indication of each recorded voice string that has not been manipulated by a user, such as being opened, played, or otherwise accessed. For example, the processor 70 may be configured to present the name of each recorded voice string that has not been manipulated by the user. The mobile terminal 10 may further include a user input device 74 configured to received input from a user, for example to enter into a voice string recording mode as discussed above or to access a voice string that was previously recorded. The user input device 74 may be, for example, a keypad 30, as shown in FIG. 1, a touch screen, or a mouse, among other devices.

Continuing the example described above, the processor 70 may present an indication of the voice memos that the user had previously recorded, but never reviewed. In a typical mobile terminal, the processor may assign a generic name to each voice, such as “Phone Memo (1)” or “Sound (1).” In order to assign a more meaningful or otherwise relevant name to the voice memo, the user may have to access a particular voice memo and manually assign a different name of her choosing, such as by entering a different name via the user input device (e.g., depressing alphanumeric keys on the keypad 30). According to embodiments of the present invention, however, the processor 70 may automatically assign the recorded voice string a name indicative of the content or a characteristic of the voice string, as previously mentioned.

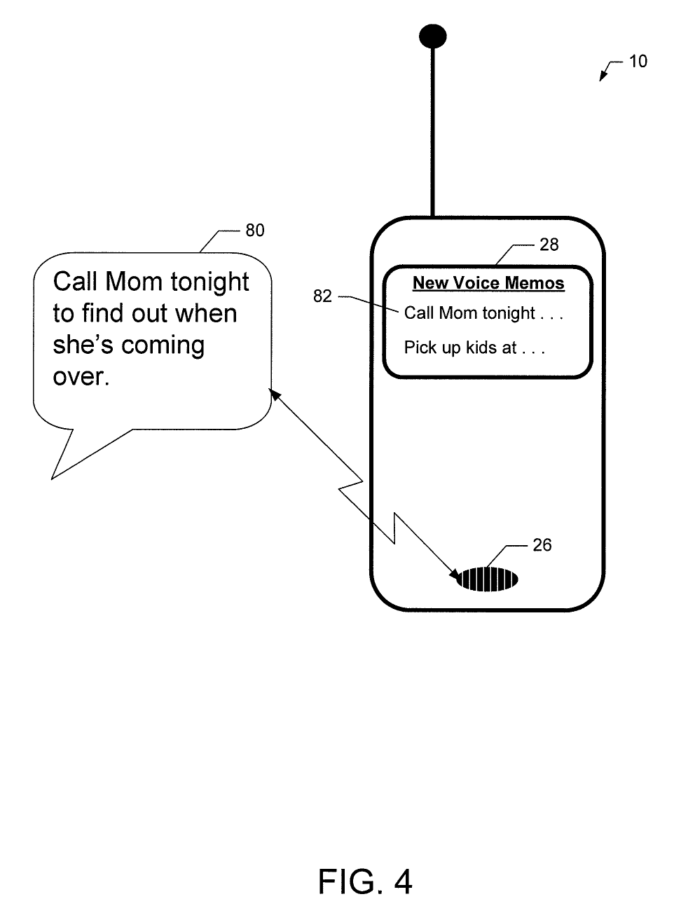

For example, referring to FIGS. 3 and 4, the user may create a voice string 80, such as by activating a voice memo recording application on the mobile terminal 10 and speaking a voice string 80 into the microphone 26 of the mobile terminal 10. In the example described in FIG. 4, the user may record the following voice string 80: “Call Mom tonight to find out when she's coming over.”

The processor 70 may automatically assign the recorded voice string 80 an indicative name in various ways. For example, the processor 70 may be configured to automatically assign the recorded voice string a name according to current location metadata. Current location metadata may describe the location of the mobile terminal 10 at the time the voice string 80 is recorded. For example, current location metadata may include the coordinates of the mobile terminal's location, an address for the location (e.g., obtained from a map service), or a name of the location that has been previously assigned by the user for a given location or area of coordinates and stored via another application of the mobile terminal 10.

As an example, the user may have assigned (e.g., using some other application) a certain set of coordinates or range of coordinates corresponding to the location of his office the location name “Office.” In this case, if the user is in or near his office when he records the voice string 80, the current location metadata associated with that voice string may indicate “Office.” Thus, the processor 70 may include “Office” in the name assigned to that particular voice string to indicate a characteristic of the voice string (i.e., the fact that the user was at the office when he recorded the voice string). In this case, the user may later see a voice memo with the name including the word “Office” and may recall the voice string he recorded in his office earlier. The current location metadata may be created via locating techniques such as trilateration using Global Positioning System (GPS) signals, cellular signals, or other signals and may involve interaction of the mobile terminal 10 with other network elements, such as those depicted in FIG. 2.

In some cases, the processor 70 may be configured to automatically assign the recorded voice string 80 a name according to a date on which the voice string is recorded. For example, if the user creating the voice string 80 in FIG. 4 records the voice string on June 3^{rd}, the name assigned to the voice string 80 may include “0603” or some other indication of the date on which the voice string was recorded. The date may include the year and/or time of day in some embodiments. In some instances, the date may be combined with another characteristic of the voice string 80, such as the current location metadata described above. In that case, the voice string 80 may be assigned a name such as “Office 0603.”

Furthermore, the processor 70 may be configured to automatically assign the recorded voice string 80 a name according to a predetermined number of initial words of the recorded voice string 80. For example, the processor 70 may consider the first three words of any given voice string 80 when assigning a name. For the voice string 80 represented in FIG. 4, the processor 70 may thus assign the name “Call Mom tonight” to the voice string 80, thereby providing a meaningful summary of the content of the particular voice string 80. Alternatively, the processor 70 may consider an initial length of the voice string 80 when assigning the name, such as the first two or three seconds of the recording. The processor 70 may, for example, be configured to automatically convert a predetermined portion (e.g., three seconds) of the recorded voice string to the name by using a speech-to-text feature or other similar technique of converting spoken words into written text.

By basing the name on the content of the voice string, the user may be able to recognize the subject of a voice string when reviewing a list 82 of unmanipulated, or new, voice strings that is presented upon the display 28 of the mobile terminal 10. This may facilitate the user's access of the voice strings and allow him to manipulate each voice string appropriately without necessarily having to access each voice string separately to hear the entire contents of each. The list 82 may, for example, be presented under a heading such as “New Voice Memos” to indicate that the displayed names have not yet been accessed, reviewed, saved, and/or otherwise manipulated since they were recorded. Upon looking at the list 82, the user may immediately identify two or three voice strings that he has already satisfied and may thus choose to delete them without reviewing the entire contents, saving himself time and his mobile terminal memory.

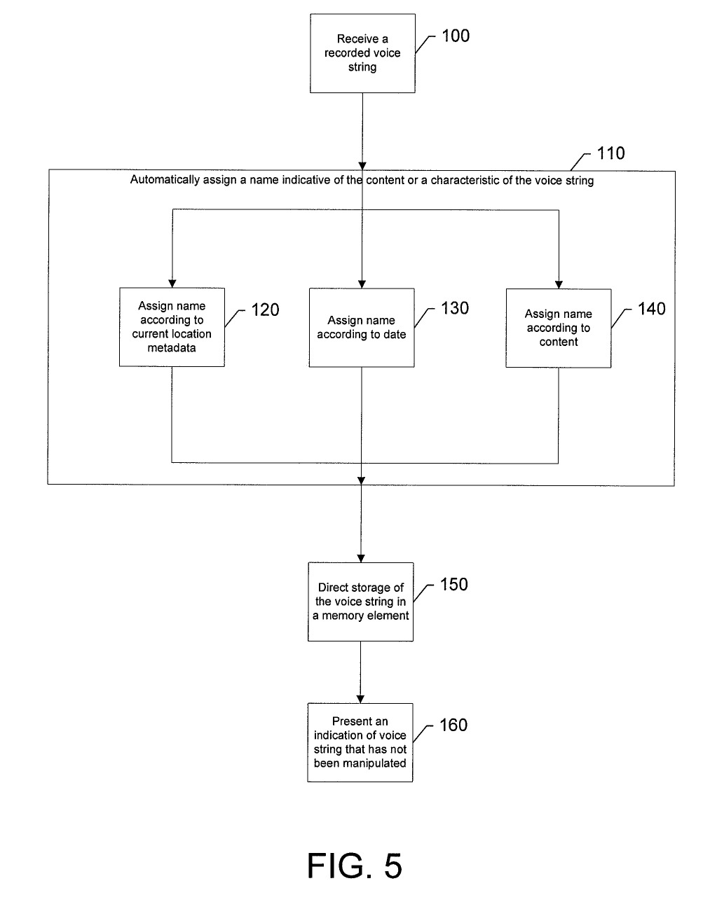

In other embodiments, a method for handling recorded voice strings is provided. Referring to FIG. 5, a recorded voice string is initially received, such as when a user of a mobile terminal records a voice memo or other message on the mobile terminal. A name indicative of the content and/or a characteristic of the voice string is then assigned to the recorded voice string to facilitate any subsequent access or manipulation of the voice string, as previously described. FIG. 5, blocks 100, 110.

The name may be assigned to the recorded voice string in various ways. For example, the name may be assigned according to current location metadata associated with the particular voice string. Block 120. As such, metadata describing the location of the mobile terminal at the time the voice string was recorded may be included or otherwise reflected in the name assigned to the voice string. The name may also be assigned according to the date on which the voice string is recorded. Block 130. As previously described, the date may include the day of the week and/or the time at which the voice string is recorded in addition to the month, day, and/or year. The date may also be included in the name along with one or more other characteristics of the voice string and/or an indication of the content.

In some cases, the name may be assigned according to the content of the voice string. Block 140. For example, the name may be automatically assigned according to a predetermined number of initial words of the recorded voice string. The first three words (or any other number of words as configured by a user or otherwise) of the voice string may be used, for example, to name the particular voice string. Referring to the example depicted in FIG. 4, a voice string consisting of the words “Call Mom tonight to find out when she's coming over” may be automatically assigned a name that includes the first three words “Call Mom tonight.” In this way, the user may recall the entire content of the voice string or at least recognize the subject matter of the voice string upon seeing the name that includes the first three words. As such, the user may be able to manipulate the voice string (e.g., save or delete the voice string) without necessarily having to listen to the entire recorded voice string. Furthermore, assigning the name may include converting a predetermined portion of the recorded voice string to the name using a speech-to-text feature. Thus, a portion of the voice string, such as the first 3 seconds of the recorded voice string or the first few words recorded, may be converted from spoken words to written text to be included in the name, as previously described.

In some embodiments, storage of the recorded voice string in a memory element, such as the non-volatile memory 42 shown in FIG. 1, may be directed. FIG. 5, Block 150. The recorded voice string may be stored and subsequently accessed from the memory element using the assigned name to identify the particular voice string.

Furthermore, an indication of each recorded voice string that has not been manipulated by a user may be presented upon a display, for example to allow a user to consider each such voice string. Block 160. In some cases, the assigned name of each recorded voice string may be presented upon the display. Thus, a user may be able to view the name or other indication of each voice string that has not been manipulated (e.g., the voice strings that the user has not yet listened to, saved, and/or deleted) and may use the name or other indication to decide on how to manipulate each voice string and what, if any, action he should take.

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as the controller 20 (shown in FIGS. 1) and/or the processor 70 (shown in FIG. 3), to function in a particular manner, such that the instructions stored in the computer-readable memory produce an article of manufacture including computer-readable instructions for implementing the function specified in the flowchart block or blocks illustrated in FIG. 5. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to receive a voice string that has been recorded, the processor further configured to automatically assign the recorded voice string a name indicative of at least one of the content or a characteristic of the voice string.

2. The apparatus of claim 1, wherein the processor is configured to automatically assign the recorded voice string a name according to current location metadata.

3. The apparatus of claim 1, wherein the processor is configured to automatically assign the recorded voice string a name according to a date on which the voice string is recorded.

4. The apparatus of claim 1, wherein the processor is configured to automatically assign the recorded voice string a name according to a predetermined number of initial words of the recorded voice string.

5. The apparatus of claim 4, wherein the processor is configured to automatically convert a predetermined portion of the recorded voice string to the name using a speech-to-text feature.

6. The apparatus of claim 1 further comprising a microphone in communication with the processor and configured to receive a voice string for recording.

7. The apparatus of claim 1 further comprising a memory element in communication with the processor and configured to store the recorded voice string.

8. The apparatus of claim 1 further comprising a display in communication with the processor, wherein the processor is configured to present upon the display an indication of each recorded voice string that has not been manipulated by a user.

9. The apparatus of claim 8, wherein the processor is configured to present upon the display the name of each recorded voice string that has not been manipulated by the user.

10. A method comprising:
receiving a recorded voice string; and
automatically assigning the recorded voice string a name indicative of at least one of the content or a characteristic of the voice string.

11. The method of claim 10, wherein automatically assigning a name comprises automatically assigning a name according to current location metadata.

12. The method of claim 10, wherein automatically assigning a name comprises automatically assigning a name according to a date on which the voice string is recorded.

13. The method of claim 10, wherein automatically assigning a name comprises automatically assigning a name according to a predetermined number of initial words of the recorded voice string.

14. The method of claim 10, wherein automatically assigning a name comprises automatically converting a predetermined portion of the recorded voice string to the name using a speech-to-text feature.

15. The method of claim 10 further comprising directing storage of the recorded voice string in a memory element.

16. The method of claim 10 further comprising presenting upon a display an indication of each recorded voice string that has not been manipulated by a user.

17. The method of claim 16, wherein presenting an indication comprises presenting the name of each recorded voice string that has not been manipulated by the user.

18. A computer program product comprising at least one computer-readable storage medium having computer-readable program code portions stored therein, the computer-readable program code portions comprising:
a first executable portion for receiving a recorded voice string; and
a second executable portion for automatically assigning the recorded voice string a name indicative of at least one of the content or a characteristic of the voice string.

19. The computer program product of claim 18, wherein the second executable portion is further configured for automatically assigning a name according to current location metadata.

20. The computer program product of claim 18, wherein the second executable portion is further configured for automatically assigning a name according to a date on which the voice string is recorded.

21. The computer program product of claim 18, wherein the second executable portion is further configured for automatically assigning a name according to a predetermined number of initial words of the recorded voice string.

22. The computer program product of claim 18, wherein the second executable portion is further configured for automatically converting a predetermined portion of the recorded voice string to the name using a speech-to-text feature.

23. The computer program product of claim 18 further comprising a third executable portion for directing the storage of the recorded voice string in a memory element.

24. The computer program product of claim 18 further comprising a third executable portion for presenting upon a display an indication of each recorded voice string that has not been manipulated by a user.

25. The computer program product of claim 24, wherein the third executable portion is further configured for presenting the name of each recorded voice string that has not been manipulated by the user.

26. An apparatus comprising:
means for receiving a recorded voice string; and
means for automatically assigning the recorded voice string a name indicative of at least one of the content or a characteristic of the voice string.
